(19) United States
(12) Patent Application Publication
(10) Pub. No.: US 2025/0220661 A1
(43) Pub. Date: Jul. 3, 2025

(54) System For Scheduling Transmissions from Ambient Power Devices

(71) Applicant: Cisco Technology, Inc., San Jose, CA (US)

(72) Inventors: Robert Barton, VANCOUVER (CA); Amine Choukir, Ecublens (CH); Juan Carlos Zuniga, MONTREAL (CA); Domenico Ficara, Essertines-sur-Yverdon (CH); Indermeet Gandhi, San Jose, CA (US); Ugo Campiglio, Ecublens (CH); Jerome Henry, Pittsboro, NC (US); Leo Caldarola, Ecublens (CH); Sachin D. Wakudkar, St-Sulpice (CH)

(21) Appl. No.: 18/597,889

(22) Filed: Mar. 6, 2024

Related U.S. Application Data
(60) Provisional application No. 63/615,200, filed on Dec. 27, 2023.

(51) Int. Cl. H04W 72/12

(52) U.S. Cl. CPC H04W 72/12

(57) ABSTRACT

Devices, networks, systems, methods, and processes for scheduling transmissions from a plurality of ambient power devices are described herein. An Access Point (AP) can detect one or more ambient power devices and retrieve one or more device identifiers associated with the one or more ambient power devices. The AP can determine one or more transmission durations associated with the one or more ambient power devices. The AP may generate at least one control frame based on the one or more device identifiers and the one or more transmission durations. In that, the AP can insert, based on the one or more transmission durations, one or more padding bits in the at least one control frame to charge or trigger the one or more ambient power devices. The AP can coordinate with a relay or a wireless device to schedule uplink transmissions from the one or more ambient power devices.

### CROSS-REFERENCE TO RELATED APPLICATION

This application claims the benefit of U.S. Provisional Patent Application No. 63/615,200, filed Dec. 27, 2023, which is incorporated by reference herein in its entirety.

The present disclosure relates to wireless communication. More particularly, the present disclosure relates to communication with ambient power devices.

### BACKGROUND

Ambient power devices can be of various types. Some ambient power devices may be passive devices that do not include batteries. Such passive devices merely reflect energy, such as Radio Frequency (RF) waves, received in real-time or in near-real time. Some other ambient power devices can be active devices that can include capacitors or batteries to store the energy. Such active devices can delay transmission of data by utilizing the stored energy. In a dynamic landscape of a large number of devices, a combination of active devices and passive devices may be utilized.

As a number of the ambient power devices increases in a network, the ambient power devices can adversely impact radio resource utilization in the network. Since the ambient power devices can operate in unlicensed Wi-Fi frequency bands, the ambient power devices can also interfere in communication between other wireless devices. Most uplink transmissions from the ambient power devices are uncoordinated, and hence, may cause collisions with the communication between the other wireless devices. The increase in the number of the ambient power devices can also increase contention for wireless medium in the network The increase in contention can cause latency, packet loss, and reduced throughput for all the wireless devices and the ambient power devices in the network, thereby decreasing network efficiency and throughput.

Further, since the ambient power devices have minimum or no processing capabilities, changes or modifications might be required to the network to mitigate the adverse effects of the increase in the number of the ambient power devices in the network. In that, the network might require modifications to existing transmission scheduling techniques. However, since not all the ambient power devices may be in communication with a network controller, there exist challenges in managing transmissions from the ambient power devices that are spread over large distances.

Therefore, there is a need to integrate the ambient power devices in the network, to mitigate the interference and collisions, and ensure fair access to the wireless medium.

### SUMMARY OF THE DISCLOSURE

Systems and methods for scheduling transmissions from multiple ambient power devices in accordance with embodiments of the disclosure are described herein. In some embodiments, a device includes a processor, and a memory communicatively coupled to the processor, wherein the memory includes a transmission scheduling logic. In some embodiments, a transmission scheduling logic is configured to detect a plurality of ambient power devices, determine one or more device identifiers associated with one or more ambient power devices of the plurality of ambient power devices, determine one or more transmission durations associated with the one or more ambient power devices, and generate at least one control frame based on the one or more device identifiers and the one or more transmission durations.

In some embodiments, the transmission scheduling logic is further configured to assign one or more frequencies to the one or more ambient power devices, and assign one or more time slots to the one or more ambient power devices.

In some embodiments, the transmission scheduling logic is further configured to generate a resource map indicative of the one or more device identifiers and at least one of the one or more frequencies or the one or more time slots.

In some embodiments, the transmission scheduling logic is further configured to generate one or more encoded identification bits based on the one or more device identifiers.

In some embodiments, the transmission scheduling logic is further configured to generate one or more padding bits based on the one or more transmission durations.

In some embodiments, the transmission scheduling logic is further configured to organize the plurality of ambient power devices into one or more zones, assign one or more zone identifiers to the one or more zones, and generate a zone map indicative of assignment of the one or more device identifiers to the one or more zone identifiers.

In some embodiments, the at least one control frame includes at least one of the one or more encoded identification bits, the one or more padding bits, the resource map, or the zone map.

In some embodiments, the at least one control frame is a trigger frame or a charging frame.

In some embodiments, the one or more transmission durations are indicative of a time required for charging the one or more ambient power devices.

In some embodiments, the transmission scheduling logic is further configured to reserve a transmission opportunity including the one or more time slots, and assign the transmission opportunity to the one or more ambient power devices.

In some embodiments, reserving the transmission opportunity includes transmitting a request to send frame or a clear to send frame to a wireless device.

In some embodiments, the transmission scheduling logic is further configured to transmit a beamformed signal to the one or more ambient power devices.

In some embodiments, the beamformed signal includes the trigger frame or the charging frame.

In some embodiments, a transmission scheduling logic is configured to detect a plurality of ambient power devices, determine one or more device identifiers associated with one or more ambient power devices of the plurality of ambient power devices, generate one or more encoded identification bits indicative of the one or more device identifiers, and generate at least one trigger frame including the one or more encoded identification bits.

In some embodiments, the transmission scheduling logic is further configured to determine one or more transmission durations associated with the one or more ambient power devices, and insert one or more padding bits in the at least one trigger frame based on the one or more transmission durations.

In some embodiments, the transmission scheduling logic is further configured to transmit the at least one trigger frame to the one or more ambient power devices.

In some embodiments, the transmission scheduling logic is further configured to receive one or more uplink frames from the one or more ambient power devices in response to the at least one trigger frame.

In some embodiments, a method includes detecting a plurality of ambient power devices, determining one or more device identifiers associated with one or more ambient power devices of the plurality of ambient power devices, determining one or more transmission durations associated with the one or more ambient power devices, and generating at least one control frame based on the one or more device identifiers and the one or more transmission durations.

In some embodiments, a method includes generating one or more encoded identification bits based on the one or more device identifiers, generating one or more padding bits based on the one or more transmission durations, and generating a resource map indicative of assignment of at least one of one or more frequencies or one or more time slots to the one or more ambient power devices.

In some embodiments, at least one control frame includes at least one of the one or more encoded identification bits, the one or more padding bits, or the resource map.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently preferred embodiments of the disclosure. As such, various other embodiments are possible within its scope. Accordingly, the scope of the disclosure should be determined not by the embodiments illustrated, but by the appended claims and their equivalents.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a conceptual illustration of a wireless communication network, in accordance with various embodiments of the disclosure;

FIG. 2 is a conceptual illustration of transmission of one or more frames in a wireless communication network, in accordance with various embodiments of the disclosure;

FIG. 3 is a conceptual illustration of a structure of a trigger frame in a wireless communication network, in accordance with various embodiments of the disclosure;

FIG. 4 is a conceptual illustration of charging one or more ambient power devices in a wireless communication network, in accordance with various embodiments of the disclosure;

FIG. 5 is a conceptual network diagram of various environments that a transmission scheduler may operate on a plurality of network devices, in accordance with various embodiments of the disclosure;

FIG. 6 is a flowchart depicting a process for generating a control frame, in accordance with various embodiments of the disclosure;

FIG. 7 is a flowchart depicting a process for generating a control frame, in accordance with various embodiments of the disclosure;

FIG. 8 is a flowchart depicting a process for inserting one or more padding bits in a control frame, in accordance with various embodiments of the disclosure;

FIG. 9 is a flowchart depicting a process for organizing a plurality of ambient power devices into one or more zones, in accordance with various embodiments of the disclosure;

FIG. 10 is a flowchart depicting a process for relaying one or more uplink frames, in accordance with various embodiments of the disclosure; and

FIG. 11 is a conceptual block diagram of a device suitable for configuration with a transmission scheduling logic, in accordance with various embodiments of the disclosure.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DETAILED DESCRIPTION

In response to the issues described above, devices and methods are discussed herein that schedule transmissions from multiple ambient power devices. A communication network may comprise an Access Point (AP) and one or more ambient power devices. The ambient power devices can be in communication with the AP by way of one or more Radio Frequency (RF) channels. The RF channels may include multiple bands of frequencies. In some embodiments, for example, the bands of frequencies may include Wi-Fi bands such as but not limited to 2.4 GHz, 5 GHz, or 6 GHz. Some more examples can include millimeter-wave (mmWave) bands. Additional examples can include Sub-1 GHz band frequencies. The ambient power devices can be powered by one or more energy sources such as, but not limited to, radio waves, light, motion, heat, or any such ambient energy sources. The ambient power devices may be active devices or passive devices. The passive devices can reflect the RF signals by backscattering. The active devices may include an energy storage such as but not limited to a battery or a capacitor. The active devices can also include a buffer to store uplink data. The uplink data from the buffer may be transmitted by way of one or more uplink frames.

In many embodiments, the AP can detect a plurality of ambient power devices. In some embodiments, the AP can utilize passive scanning, beacon frames, probe requests and responses, analysis of backscatter signals, etc. to detect the ambient power devices. The ambient power devices may share one or more device characteristics with the AP during association with the AP. In some embodiments, for example, the ambient power devices can share the device characteristics with the AP by way of a Manufacturer Usage Description (MUD) Uniform Resource Locator (URL) or MUD data. The AP may determine the device identifiers associated with the ambient power devices based on the device characteristics received from the ambient power devices. In some embodiments, examples of the device identifiers can include, but are not limited to Electronic Product Code (EPC), Media Access Control (MAC) address, serial number, Unique Identifier (UID) or any other such identifiers. The ambient power devices may also share one or more transmission requirements with the AP. In certain embodiments, examples of the transmission requirements can include, but are not limited to a charge level required for transmitting one or more uplink frames, a time required to charge the energy storage, a buffer size of the buffer, duty cycle of the uplink frames, duty cycle of one or more charging frames required to charge the energy storage etc. or other such transmission requirements. The ambient power devices can also share one or more power requirements with the AP. In more embodiments, examples of the power requirements can include, but are not limited to a maximum energy storage capacity of the battery or the capacitor.

The AP may utilize the device characteristics, including device identifiers, the transmission requirements, and/or power requirements of the ambient power devices to schedule the transmission of the uplink frames transmitted by the ambient power devices. The AP can utilize triggered uplink transmission by way of Orthogonal Frequency Division Multiple Access (OFDMA) to schedule the transmission of the uplink frames. The AP may also schedule the uplink transmissions by utilizing one or more wireless devices or relays in communication with the AP and the ambient power devices. The relay or the wireless device can also be an energizer device to charge or recharge the ambient power devices. The ambient power devices can be configured in multi-user uplink operation mode, where multiple ambient power devices may transmit the uplink frames simultaneously. In that, the AP may trigger the multiple ambient power devices simultaneously.

The AP can utilize a multi-user trigger frame or a broadcast trigger frame to trigger the multiple ambient power devices simultaneously. The AP may transmit a trigger frame comprising one or more uplink transmission parameters or resource allocation data. The uplink transmission parameters or resource allocation data can be utilized by the ambient power devices to generate a Physical Layer Protocol Data Unit (PPDU). The ambient power devices may generate and transmit the uplink frames indicative of the PPDU. The ambient power devices can transmit the uplink frames to the AP or the wireless device by way of backscattering the incident RF signals. In some more embodiments, examples of the backscatter communication between the ambient power devices and the wireless device or the AP include but are not limited to monostatic backscatter, bistatic backscatter, and ambient backscatter.

In a number of embodiments, the AP can assign one or more frequencies or time slots to the ambient power devices. In some embodiments, for example, the AP can assign one or more RF channels to each ambient power device. The frequencies of the RF channels may be within one or more bands of Wi-Fi. The AP may assign the RF channels to the ambient power devices to avoid or minimize collisions between uplink transmissions of the ambient power devices. In certain embodiments, the one or more time slots assigned to the ambient power devices can be within a same Transmission Opportunity (TXOP) or across multiple TXOPs. The time slots can be predetermined or can be dynamically selected by the AP. The AP may continuously monitor network conditions or collisions and may optimize or modify the assigned time slots and frequencies based on changes in the network conditions. In more embodiments, the ambient power devices with larger energy storage capacity may be assigned longer time slots or greater bandwidth, for example. In some more embodiments, the ambient power devices associated with prioritized data transmission or prioritized functions can be assigned longer time slots or greater bandwidth, for example. In numerous embodiments, the AP can exchange control frames, management frames, or downlink frames with the ambient power devices to signal the assignment of the time slots and frequencies.

In various embodiments, the AP can generate the control frame indicative of the device identifiers of the ambient power devices to be triggered and the assignment of the time slots and frequencies to the ambient power devices. The control frame can include a resource map indicative of the device identifiers of the ambient power devices and the assigned time slots and/or frequencies. The ambient power devices may receive the control frame and retrieve the resource map from the control frame. The ambient power devices can determine the assigned time slots and/or frequencies based on the device identifiers. The ambient power devices may utilize the assigned time slots and/or frequencies to transmit the uplink frames. In some embodiments, the control frame may be indicative of an order of transmission of the uplink frames or the order in which the ambient power devices may transmit the uplink frames.

In additional embodiments, the AP may determine a transmission duration associated with each ambient power device. The transmission duration may be indicative of a time required by the ambient power device for transmitting the uplink frames. In some embodiments, the transmission duration can be associated with the charge level required by the ambient power device, for example. The transmission duration may also be associated with the energy storage within the ambient power device, for example. The transmission duration can also be associated with a distance of the ambient power device from the AP, location or position of the ambient power device, density of the ambient power devices in a location, or charge accumulated by the ambient power device from a charging frame, etc. for example. The transmission duration may be associated with time required for the ambient power device to generate the uplink data, measure one or more physical parameters that are required to generate the uplink data, process the uplink data, or encode the uplink data. In that, in certain embodiments, for example, the ambient power devices can be sensors such as but not limited to temperature sensors, humidity sensors, pressure sensors, health sensors, etc. and hence, may require time to measure temperature, pressure, humidity, or health values etc. respectively, for example. In such cases, the AP can take into consideration the time required by the ambient power devices to generate, process, and transmit the uplink data. The AP may also determine a number of charging frames or a number of bits required in the control frame based on the transmission duration. The AP can further determine, based on the transmission duration, a number of padding bits required in the control frame to recharge the energy storage of the ambient power device. The padding bits can be a sequence of Is. The AP may insert the padding bits in the control frame. The ambient power device can utilize the padding bits in the control frame to recharge the energy storage such as the battery or the capacitor, and thereafter transmit the uplink frame. The AP may send multiple padding bits for each uplink frame to be received from the ambient power device. The AP can also trigger the uplink transmission from the ambient power devices that are passive devices by utilizing the control frame. In that, the control frame can include a preliminary wake-up phrase, trigger data, and carrier data. The preliminary wake-up phrase can be utilized to the wake up or initialize the ambient power device. The preliminary wake-up phrase may include the device identifier which the ambient power device may detect to identify and receive the control frame directed to the ambient power device. The trigger data may be indicative of the resource map. The carrier data can be indicative of the RF frequencies that the ambient power device may utilize to backscatter the uplink frames to the AP or the wireless device. In certain embodiments, the AP may skip a Short Interframe Space (SIFS) if the control frame is extended by inserting the padding bits. The AP can also transmit the padding bits or one or more charging frames including the padding bits during the SIFS. In more embodiments, multiple ambient power devices can be charged or recharged simultaneously by way of the charging frames or the padding bits in the control frame. In some more embodiments, the AP may transmit the trigger frame, the charging frame, the downlink frame, the management frame, or the control frame to charge or trigger the ambient power devices.

In further embodiments, the wireless device may transmit a Request To Send (RTS) frame to the AP to reserve the TXOP. The AP can respond to the RTS by transmitting a Clear to Send (CTS) frame. The wireless device can also reserve the TXOP by transmitting a CTS2Self frame. The TXOP may include the time slots and/or the frequencies. The wireless device may utilize the TXOP for uplink transmission of the uplink frames by the ambient power device. That is, the wireless device can transfer the reserved TXOP to the ambient power devices. The wireless device may also supervise the uplink transmission by the ambient power devices. In some embodiments, the wireless device can receive the uplink frames from the ambient power devices and relay the uplink frames to the AP. The wireless device may receive the control frame, the trigger frame, or the management frame from the AP and may relay the control frame, the trigger frame, or the management frame to the ambient power devices to trigger the uplink transmission. The wireless device may also assign the time slots and/or frequencies associated with the TXOP to the ambient power devices.

In many more embodiments, the wireless device or the AP may utilize spatial diversity to charge or trigger the ambient power devices by way of beamforming. The beamforming can be performed to charge or trigger the ambient power devices in different locations or different directions. The AP or the wireless device can also utilize an 802.11 frame as the control frame, the trigger frame, or the management frame to schedule the uplink transmissions from the ambient power devices or to charge the ambient power devices. The control frame, the trigger frame, or the management frame can be identified and processed by the ambient power devices. In numerous embodiments, the control frame may be the trigger frame or the charging frame.

In many additional embodiments, the control frame can comprise one or more encoded identification bits associated with the device identifiers of the ambient power devices. The ambient power device can detect and identify the encoded identification bits and thereby determine whether the control frame is directed to the ambient power device. In some embodiments, the control frame may be transmitted independently. In certain embodiments, the control frame can also be transmitted along with the trigger frame. In more embodiments, the trigger frame may comprise the control frame. In some more embodiments, a preamble of the trigger frame can comprise the control frame.

In many further embodiments, the ambient power device can receive the control frame comprising the trigger data. The ambient power device may determine that the control frame is directed to the ambient power device based on the encoded identification bits. The ambient power device can charge the battery or the capacitor based on the control frame. The ambient power device may wait for the duration of the SIFS and then transmit the uplink frame. The uplink frame may be indicative of the uplink data measured, processed, or generated by the ambient power device. The uplink frame can be transmitted by the ambient power device by backscattering the control frame.

In still many embodiments, the AP and/or the wireless device can receive the uplink frame and transmit an acknowledgement frame to the ambient power device. In some embodiments, the AP and/or the wireless device may transmit a multi-user bulk acknowledgement frame to the multiple ambient power devices. Similarly, the AP and/or the wireless device can trigger the multiple ambient power devices by transmitting a broadcast trigger frame or a multi-cast trigger frame. In such cases, the broadcast trigger frame or the multi-cast trigger frame can trigger the uplink transmissions from the multiple ambient power devices by way of one or more multiplexing techniques, such as but not limited to OFDMA, etc., for example. The broadcast trigger frame or the multi-cast trigger frame may also assign Resource Units (RUs) to the multiple ambient power devices. The broadcast trigger frame or the multi-cast trigger frame can indicate times of uplink transmissions assigned to the multiple ambient power devices. The broadcast trigger frame or the multi-cast trigger frame may also indicate the time slots and frequencies assigned to the multiple ambient power devices for the uplink transmissions. The RUs, time slots, frequencies, or TXOPs can be utilized by the ambient power devices to renegotiate the transmission requirements. In that, the ambient power devices can retransmit new or updated device characteristics to the AP and/or the wireless device. In some embodiments, for example, the AP and/or the wireless device can utilize legacy modulation techniques so that all ambient power devices can decode the broadcast trigger frame or the multi-cast trigger frame. In more embodiments, entire duration of TXOP can be reserved for one or more ambient power devices.

In still further embodiments, the AP and/or the wireless device can organize the ambient power devices into one or more zones. Each zone may be assigned a zone identifier. The AP and/or the wireless device can generate a zone map. The zone map may be indicative of assignment of the one or more ambient power devices to one or more zones. In some embodiments, the zones can be formed based on types of devices, position of devices, device characteristics, device types, or priorities associated with the device etc. for example. The control frame can be further indicative of the zone map. Upon receiving the control frame, the ambient power device may determine the zone that corresponds to the ambient power device. Thereafter, the AP and/or the wireless device can transmit the trigger frames or the charging frames to the zones, i.e., to the ambient power devices in the zone. The AP and/or the wireless device can utilize the multi-user acknowledgment frame and the multi-cast trigger frame for each zone. In certain embodiments, the ambient power devices, the AP, or the wireless device can change positions. In that case, the AP and/or the wireless device may generate a new or updated zone map and transmit the new or updated zone map to the ambient power devices. In more embodiments, the zone map can be further indicative of the assignment of the time slots, frequencies, or order of transmission associated with the ambient power devices in the zones. The zone map may also be indicative of RUs assigned to each ambient power device.

Advantageously, the transmission scheduling technique of the present disclosure can extend triggered uplink transmission from synchronized OFDMA devices to asynchronous ambient power devices. The transmission scheduling technique of the present disclosure can also integrate the ambient power devices in the wireless network. The AP may dynamically charge the ambient power devices and/or trigger uplink transmissions by the ambient power devices. The AP can further respond to changes in the network conditions or changes in topology of the ambient power devices by updating the zones.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.”. Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may alternatively be embodied by or implemented as a component.

A circuit, as used herein, comprises a set of one or more electrical and/or electronic components providing one or more pathways for electrical current. In certain embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may be embodied by or implemented as a circuit.

Reference throughout this specification to “one embodiment,” “an embodiment,” or similar language means that a feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.”. An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

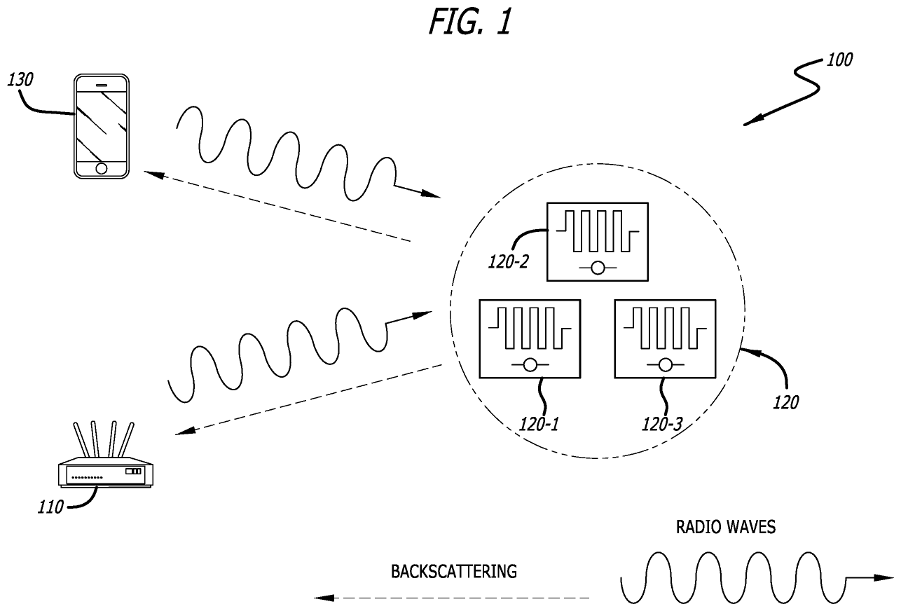

Referring to FIG. 1, a conceptual illustration of a wireless communication network 100, in accordance with various embodiments of the disclosure is shown. In many embodiments, the wireless communication network 100 may include an Access Point (AP) 110, a plurality of ambient power devices 120 including first through third ambient power devices 120-1, 120-2, and 120-3, and a wireless device 130. The ambient power devices 120 may be powered by one or more energy sources such as, but not limited to, radio waves, light, motion, heat, or any such ambient energy sources. The ambient power devices 120 may be active devices, i.e., with an energy storage capacity such as a battery or a capacitor etc. or the ambient power devices 120 can be passive devices. The ambient power devices 120 can receive one or more Radio Frequency (RF) signals. The ambient power devices 120 may backscatter the RF signals. In some embodiments, the ambient power devices 120 can modulate and backscatter incident RF signals. In certain embodiments, the ambient power devices 120 can be in communication with the AP 110 by utilizing Wi-Fi bands such as but not limited to 2.4 GHz, 5 GHz, or 6 GHz. Some more examples can include millimeter-wave (mm Wave) bands. Additional examples can include Sub-1 GHz band frequencies. Examples of the backscatter communication between the ambient power devices 120, the AP 110, and the wireless device 130 include but are not limited to monostatic backscatter, bistatic backscatter, and ambient backscatter. The wireless device 130 may function as a receiver for backscatter transmission from the ambient power devices 120. Examples of the wireless device 130 include but are not limited to smartphone, tablet, computer, an RF Identification (RFID) tag reader, etc. In certain embodiments, for example, the ambient power devices 120 may be associated with a consumer electronic device or an Internet of Things (IoT) enabled device.

In a number of embodiments, the AP 110 can detect the ambient power devices 120. The ambient power devices 120 may share one or more device characteristics with the AP 110 during association with the AP 110. The AP 110 may determine the device identifiers associated with the ambient power devices 120 based on the device characteristics received from the ambient power devices 120. The AP 110 can retrieve one or more transmission requirements or power requirements associated with the ambient power devices 120 from the device characteristics received from the ambient power devices 120. The AP 110 can assign one or more frequencies and/or one or more time slots to the ambient power devices 120. In numerous embodiments, the AP 110 can transmit control frames, management frames, or downlink frames to the ambient power devices 120 to signal the assignment of the time slots and frequencies. In some embodiments, the control frames, management frames, or downlink frames may be indicative of an order of transmission of the uplink frames or the order in which the ambient power devices 120 may transmit the uplink frames. The uplink frames can be indicative of uplink data.

In various embodiments, the AP 110 can take into consideration the time required by the ambient power devices 120 to generate, process, and transmit the uplink data. In that, the AP 110 may determine the transmission duration based on the time required by the ambient power devices 120 to generate, process, and transmit the uplink data. Thereafter, the AP 110 can determine a number of padding bits required to recharge the energy storages of the ambient power devices 120. The AP 110 may insert the padding bits into the control frames, management frames, or downlink frames.

In additional embodiments, the control frame may be the trigger frame or the charging frame. The control frame can include a resource map indicative of the device identifiers of the ambient power devices 120 and the assigned time slots and/or frequencies. The ambient power devices 120 may receive the control frame and retrieve the resource map from the control frame. The ambient power devices 120 can determine the assigned time slots and/or frequencies based on the device identifiers. The ambient power devices 120 may utilize the assigned time slots and/or frequencies to transmit the uplink frames. The control frame can further comprise a preliminary wake-up phrase, trigger data, and carrier data. The preliminary wake-up phrase may include the device identifiers which the ambient power devices 120 may detect to identify and receive the control frame directed to the ambient power devices 120. The trigger data may be indicative of the resource map. The carrier data can be indicative of the RF frequencies that the ambient power devices 120 may utilize to backscatter the uplink frames to the AP 110 or the wireless device 130.

In further embodiments, the wireless device 130 may transmit a Request To Send (RTS) frame to the AP 110 to reserve a Transmission Opportunity (TXOP). The AP 110 can respond to the RTS by transmitting a Clear to Send (CTS) frame. The wireless device 130 can also reserve the TXOP by transmitting a CTS2Self frame. The TXOP may include the time slots and/or the frequencies. The wireless device 130 may utilize the TXOP for uplink transmission of the uplink frames by the ambient power devices 120. That is, the wireless device 130 can transfer the reserved TXOP to the ambient power devices 120. The wireless device 130 may also supervise the uplink transmission by the ambient power devices 120. In some embodiments, the wireless device 130 can receive the uplink frames from the ambient power devices 120 and relay the uplink frames to the AP 110. The wireless device 130 may receive the control frame, the trigger frame, or the management frame from the AP 110 and may relay the control frame, the trigger frame, or the management frame to the ambient power devices 120 to trigger the uplink transmission. The wireless device 130 can assign the time slots and/or frequencies associated with the TXOP to the ambient power devices 120.

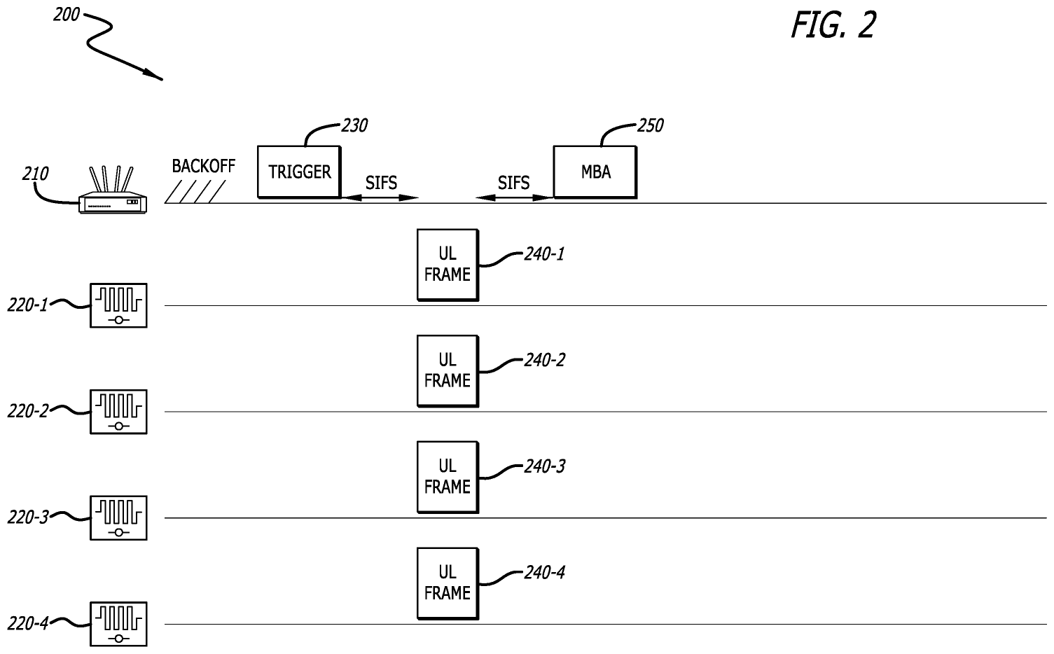

Although a specific embodiment for the wireless communication network 100 for carrying out the various steps, processes, methods, and operations described herein is discussed with respect to FIG. 1, any of a variety of systems and/or processes may be utilized in accordance with embodiments of the disclosure. For example, wireless device 130 can function as a relay between the AP 110 and the ambient power devices 120. The elements depicted in FIG. 1 may also be interchangeable with other elements of FIGS. 2-11 as required to realize a particularly desired embodiment.

Referring to FIG. 2, a conceptual illustration of a transmission of one or more frames in a wireless communication network 200, in accordance with various embodiments of the disclosure is shown. In many embodiments, the wireless communication network 200 may include the AP 210 and the plurality of ambient power devices 220 including first through fourth ambient power devices 220-1 to 220-4. The AP 210 can transmit the trigger frame 230 to the ambient power devices 220 after a backoff period. The trigger frame 230 can comprise the control frame. In some embodiments, a preamble of the trigger frame 230 may comprise the control frame. The trigger frame 230 can be indicative of the device identifiers of the ambient power devices 220, the resource map, the assignment of the time slots and/or frequencies to the ambient power devices 220, the TXOP associated with the ambient power devices 220, etc. for example. The trigger frame 230 may be transmitted to a single ambient power device. The trigger frame 230 can be a multi-cast or broadcast trigger frame transmitted to the ambient power devices 220. The trigger frame 230 may include one or more encoded identification bits indicative of the device identifiers of the ambient power devices 220. The ambient power devices 220 can receive the trigger frame 230 and charge the charge the battery or the capacitor of the ambient power devices 220 based on the trigger frame 230. The ambient power devices 220 may wait for the duration of a Short Interframe Space (SIFS) and then transmit uplink frames 240 including first through fourth uplink frames 240-1 to 240-4. The uplink frames 240 may be indicative of the uplink data measured, processed, or generated by the ambient power devices 220. The uplink frames 240 can be transmitted by the ambient power devices 220 by backscattering the trigger frame 230. The AP 210 can receive the uplink frames 240 and transmit a multi-user bulk acknowledgement frame 250 to the ambient power devices 220. The AP 210 may also transmit an acknowledgement frame separately to each ambient power device.

Although a specific embodiment for the wireless communication network 200 for carrying out the various steps, processes, methods, and operations described herein is discussed with respect to FIG. 2, any of a variety of systems and/or processes may be utilized in accordance with embodiments of the disclosure. For example, the AP 210 may dynamically schedule the uplink transmissions from the ambient power devices 220. The elements depicted in FIG. 2 may also be interchangeable with other elements of FIG. 1 and FIGS. 3-11 as required to realize a particularly desired embodiment.

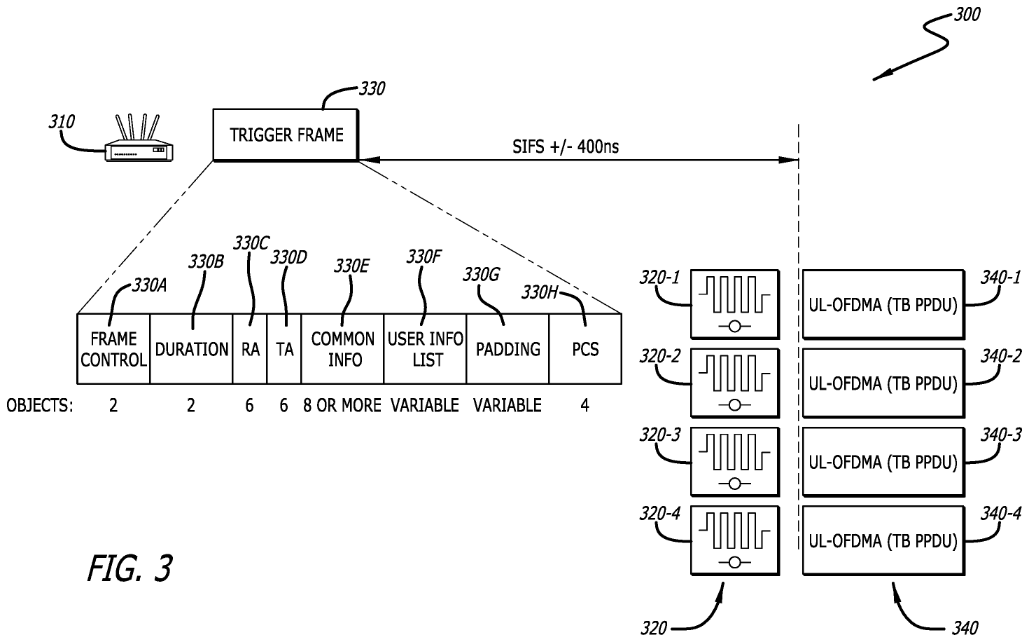

Referring to FIG. 3, a conceptual illustration of a structure of a trigger frame in a wireless communication network 300, in accordance with various embodiments of the disclosure is shown. In many embodiments, the wireless communication network 300 may include an AP 310 and a plurality of ambient power devices 320 including first through fourth ambient power devices 320-1 to 320-4. The AP 310 may generate a trigger frame 330 and transmit the trigger frame 330 to the ambient power devices 320.

In many embodiments, the trigger frame 330 can include a frame control 330A, a duration 330B, a Receiver Address (RA) 330C, a Transmitter Address (TA) 330D, common information 330E, user information list 330F, the padding bits 330G, and Frame Check Sequence (FCS) 330H. In some embodiments, the trigger frame 330 may also include more fields in addition to fields 330A-330H or may not include all the fields 330A-330H. The frame control 330A can be indicative of one or more of: a protocol utilized by the AP 310, a type of frame, or sub-type, etc. The duration 330B may be indicative of a number of microseconds or any duration of time indicative of an airtime that can be reserved for the acknowledgement frame. The duration 330B may also include a value of a Network Allocation Vector (NAV). The RA 330C and the TA 330D can be indicative of Media Access Control (MAC) addresses of the AP 310 and the ambient power devices 320. The common information 330E can be indicative of a type of the trigger frame 330, a transmission power of the trigger frame 330, one or more parameters of the trigger frame 330 such as but not limited to Trigger-based (TB) Physical Layer Protocol Data Unit (PPDU), Legacy Signal (L-SIG) field, bandwidth, guard interval, or symbol duration, etc. for example. The user information list 330F can be indicative of one or more user information fields for the ambient power devices 320. The padding bits 330G may be determined by time duration required for uplink transmission by the ambient power devices 320 or the time required for charging the ambient power devices 320. The FCS 330H may include an error-detecting code to detect and correct errors in the transmission of the trigger frame 330.

In a number of embodiments, the ambient power devices 320 may receive the trigger frame 330 and determine the RUs, the time slots, the frequencies, the transmission orders or the TXOPs assigned to the ambient power devices 320. The ambient power devices 320 can thereafter generate and transmit the uplink frames 340 including first through fourth uplink frames 340-1 to 340-4. In some embodiments, the uplink frames 340 can be transmitted by way of backscattering. In some more embodiments, the uplink frames 340 may be transmitted by way of OFDMA to avoid or minimize collisions.

Although a specific embodiment for the wireless communication network 300 for carrying out the various steps, processes, methods, and operations described herein is discussed with respect to FIG. 3, any of a variety of systems and/or processes may be utilized in accordance with embodiments of the disclosure. For example, the AP 310 may generate and transmit an 802.11 frame, i.e., a Wi-Fi frame that can be processed by the ambient power devices 320 to charge and/or trigger the ambient power devices 320. The elements depicted in FIG. 3 may also be interchangeable with other elements of FIGS. 1-2 and FIGS. 4-11 as required to realize a particularly desired embodiment.

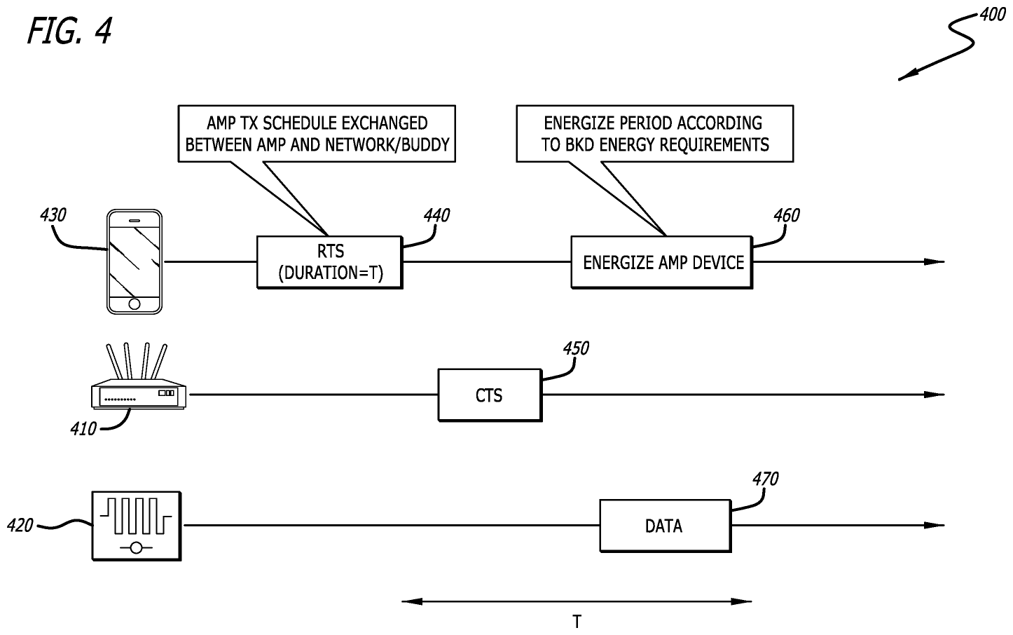

Referring to FIG. 4, a conceptual illustration of charging one or more ambient power devices in a wireless communication network 400, in accordance with various embodiments of the disclosure is shown. In many embodiments, the wireless communication network 400 may include an AP 410, an ambient power device 420, and a wireless device 430. The wireless device 430 can transmit an RTS frame 440 to the AP 410 to reserve the TXOP. The AP 410 may respond to the RTS frame 440 by transmitting a CTS frame 450. The CTS frame 450 may be indicative of the TXOP. The wireless device 430 may transfer the reserved TXOP to the ambient power device 420. The wireless device 430 can generate and transmit a trigger frame 460 to energize the ambient power device 420. The ambient power device 420 may receive the trigger frame 460 and transmit the uplink data in form of an uplink frame 470. In some embodiments, the ambient power device 420 can be the passive device that backscatters the trigger frame 460. In certain embodiments, the ambient power device 420 can be the active device that recharges the energy storage based on the trigger frame 460. The active device can thereafter utilize the stored charge for more uplink transmissions in future. In more embodiments, the uplink frame 470 can be received by the AP 410 and/or the wireless device 430. The wireless device 430 can receive the uplink frame 470 and relay the uplink frame to the AP 410.

Although a specific embodiment for the wireless communication network 400 for carrying out the various steps, processes, methods, and operations described herein is discussed with respect to FIG. 4, any of a variety of systems and/or processes may be utilized in accordance with embodiments of the disclosure. For example, the wireless device 430 may function as the receiver, the energizer, or the relay for the ambient power device 420. The elements depicted in FIG. 4 may also be interchangeable with other elements of FIGS. 1-3 and FIGS. 5-11 as required to realize a particularly desired embodiment.

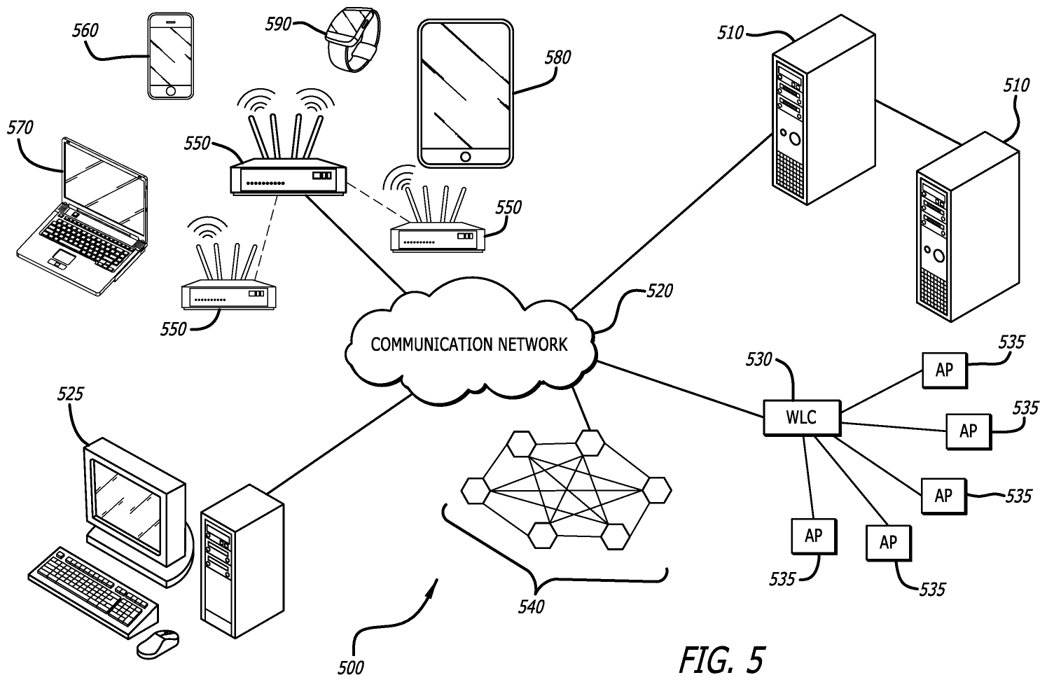

Referring to FIG. 5, a conceptual network diagram 500 of various environments that a transmission scheduler may operate on a plurality of network devices, in accordance with various embodiments of the disclosure is shown. Those skilled in the art will recognize that the transmission scheduler can be comprised of various hardware and/or software deployments and can be configured in a variety of ways. In many embodiments, the transmission scheduler can be configured as a standalone device, exist as a logic in another network device, be distributed among various network devices operating in tandem, or remotely operated as part of a cloud-based network management tool. In further embodiments, one or more servers 510 can be configured with or otherwise operate the transmission scheduler. In many embodiments, the transmission scheduler may operate on one or more servers 510 connected to a communication network 520. The communication network 520 can include wired networks or wireless networks. In many embodiments, the communication network 520 may be a Wi-Fi network operating on various frequency bands, such as, 2.4 GHz, 5 GHz, or 6 GHz. In further embodiments, the transmission scheduler operating on the servers 510 can facilitate in scheduling transmissions from one or more ambient power devices. The transmission scheduler can be provided as a cloud-based service that can service remote networks, such as, but not limited to a deployed network 540. In many embodiments, the transmission scheduler can be a logic that coordinates with the one or more wireless devices to facilitate charging the ambient power devices.

However, in additional embodiments, the transmission scheduler may be operated as a distributed logic across multiple network devices. In the embodiment depicted in FIG. 5, a plurality of APs 550 can operate as the transmission scheduler in a distributed manner or may have one specific device operate as the transmission scheduler for all of the neighboring or sibling APs 550. The APs 550 facilitate Wi-Fi connections for various electronic devices, such as but not limited to mobile computing devices including laptop computers 570, cellular phones 560, portable tablet computers 580 and wearable computing devices 590.

In further embodiments, the transmission scheduler may be integrated within another network device. In the embodiment depicted in FIG. 5, a wireless LAN controller (WLC) 530 may have an integrated transmission scheduler that the WLC 530 can use to manage the uplink transmissions within the various APs 535 that the WLC 530 is connected to, either wired or wirelessly. In still more embodiments, a personal computer 525 may be utilized to access and/or manage various aspects of the transmission scheduler, either remotely or within the network itself. In the embodiment depicted in FIG. 5, the personal computer 525 communicates over the communication network 520 and can access the transmission scheduler of the servers 510, or the network APs 550, or the WLC 530.

Although a specific embodiment for various environments that the transmission scheduler may operate on a plurality of network devices suitable for carrying out the various steps, processes, methods, and operations described herein is discussed with respect to FIG. 5, any of a variety of systems and/or processes may be utilized in accordance with embodiments of the disclosure. In many non-limiting examples, the transmission scheduler may be provided as a device or software separate from the network devices or the transmission scheduler may be integrated into the network devices. The elements depicted in FIG. 5 may also be interchangeable with other elements of FIGS. 1-4 and 6-11 as required to realize a particularly desired embodiment.

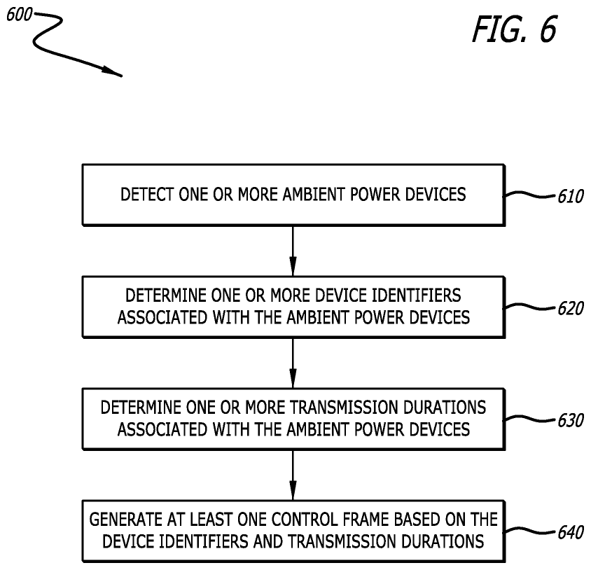

Referring now to FIG. 6, a flowchart depicting a process 600 for generating the control frame, in accordance with various embodiments of the disclosure is shown. In many embodiments, the process 600 can detect the ambient power devices (block 610). In some embodiments, the process 600 can be performed by the AP or the wireless device. In certain embodiments, the process 600 may utilize passive scanning, beacon frames, probe requests and responses, or analysis of backscatter signals, etc. to detect the ambient power devices. In more embodiments, the ambient power devices may share the device characteristics with the process 600 during association with the AP. In some more embodiments, for example, the ambient power devices can share the device characteristics with the process 600 by way of a Manufacturer Usage Description (MUD) Uniform Resource Locator (URL) or MUD data.

In a number of embodiments, the process 600 can determine the device identifiers associated with the ambient power devices (block 620). In some embodiments, examples of the device identifiers can include, but are not limited to Electronic Product Code (EPC), Media Access Control (MAC) address, serial number, Unique Identifier (UID) or any other such identifiers. In certain embodiments, the process 600 can also determine types of the ambient power devices, groups/zones of the ambient power devices, states or modes of the ambient power devices or the locations of the ambient power devices etc.

In various embodiments, the process 600 may determine the transmission durations associated with the ambient power devices (block 630). In some embodiments, the transmission duration may be indicative of the time required by the ambient power device for transmitting the uplink frames. In certain embodiments, the transmission duration can be associated with the charge level required by the ambient power device, for example. In more embodiments, the transmission duration may also be associated with the energy storage within the ambient power device, for example. In some more embodiments, the transmission duration can also be associated with a distance of the ambient power device from the AP, location or position of the ambient power device, density of the ambient power devices in a location, or charge accumulated by the ambient power device from a charging frame, etc. for example. In numerous embodiments, the transmission duration may be associated with time required for the ambient power device to generate uplink data, measure one or more physical parameters required to generate the uplink data, process the uplink data, or encode the uplink data.

In additional embodiments, the process 600 can generate the control frame based on the device identifiers and transmission durations (block 640). In some embodiments, the control frame can include the resource map indicative of the device identifiers of the ambient power devices and the assigned time slots and/or frequencies. In certain embodiments, the control frame can further comprise the preliminary wake-up phrase, trigger data, and carrier data. In more embodiments, the preliminary wake-up phrase may include the device identifiers which the ambient power devices may detect to identify and receive the control frame directed to the ambient power devices. In some more embodiments, the trigger data may be indicative the resource map. In numerous embodiments, the carrier data can be indicative of the RF frequencies that the ambient power devices may utilize to backscatter the uplink frames. In many further embodiments, the process 600 can determine the number of padding bits required to recharge the energy storages of the ambient power devices. In still more embodiments, the process 600 may insert the padding bits into the control frames based on the transmission durations to recharge and/or trigger the ambient power devices.

Although a specific embodiment for the process 600 for generating the control frame for carrying out the various steps, processes, methods, and operations described herein is discussed with respect to FIG. 6, any of a variety of systems and/or processes may be utilized in accordance with embodiments of the disclosure. For example, the process 600 may schedule transmissions of the uplink frames by transmitting the control frames to the ambient power devices. The elements depicted in FIG. 6 may also be interchangeable with other elements of FIGS. 1-5 and FIGS. 7-11 as required to realize a particularly desired embodiment.

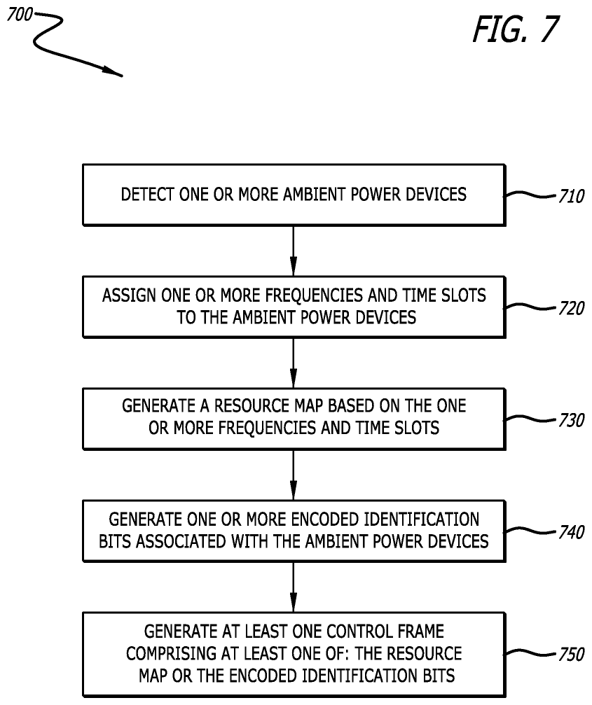

Referring now to FIG. 7, a flowchart depicting a process 700 for generating the control frame, in accordance with various embodiments of the disclosure is shown. In many embodiments, the process 700 can detect the ambient power devices (block 710). In some embodiments, the process 700 can be performed by the AP or the wireless device. In certain embodiments, the process 700 may utilize passive scanning, beacon frames, probe requests and responses, analysis of backscatter signals, etc. to detect the ambient power devices. In more embodiments, the ambient power devices may share the device characteristics with the process 700 during association with the AP. In some more embodiments, for example, the ambient power devices can share the device characteristics with the process 700 by way of the MUD URL. In many more embodiments, the process 700 can determine the device identifiers associated with the ambient power devices. In some embodiments, examples of the device identifiers can include, but are not limited to EPC, MAC address, serial number, UID or any other such identifiers. In certain embodiments, the process 700 can also determine types of the ambient power devices, groups/zones of the ambient power devices, states or modes of the ambient power devices or the locations of the ambient power devices etc.

In a number of embodiments, the process 700 can assign the frequencies and time slots to the ambient power devices (block 720). In some embodiments, the process 700 can assign the frequencies based on available spectrum, interference levels, and regulatory requirements, for example. In certain embodiments, the process 700 may assign, to each ambient power device, one or more frequencies from a set of frequencies. In more embodiments, the process 700 can assign, to each ambient power device, one or more time slots in one or more TXOPs. In some more embodiments, the process 700 may assign the frequencies and time slots based on one or more of: level of activity of the ambient power devices, volume of the uplink data, and Quality of Service (QoS) requirements etc. for example. In numerous embodiments, the process 700 can utilize one or more resource management techniques such as but not limited to dynamic channel allocation and time division multiple access (TDMA) to optimize the assignment of the frequencies and time slots. In many further embodiments, the process 700 may periodically or dynamically re-evaluate, change, or modify the assignment of the frequencies and time slots based on changes in network conditions, device activity, or environmental factors etc. for example. In still more embodiments, the process 700 can utilize one or more Machine Learning (ML) techniques for optimizing the allocation of the RUs to the ambient power devices.

In various embodiments, the process 700 may generate the resource map based on the frequencies and time slots (block 730). In some embodiments, the resource map may be a matrix indicative of the device identifiers and the frequencies and/or time slots assigned to the device identifiers. In certain embodiments, the process 700 can generate a separate resource map for each zone of ambient power devices or a single resource map for all the zones. In more embodiments, the resource map can also be indicative of zone identifiers. In some more embodiments, the resource map may include the zone identifiers and the device identifiers for the ambient power devices in the zones.

In additional embodiments, the process 700 can generate the encoded identification bits associated with the ambient power devices (block 740). In some embodiments, the encoded identification bits can be indicative of the device identifiers. In certain embodiments, the process 700 may utilize legacy modulation techniques to generate the encoded identification bits. In more embodiments, the process 700 can encode the device identifiers based on the protocol utilized for communication with the ambient power devices. In some more embodiments, the ambient power devices may decode the device identifiers, i.e., the encoded identification bits from the received control frame by utilizing the same or similar decoding techniques or the same protocol.

In further embodiments, the process 700 may generate the control frame comprising at least one of: the resource map or the encoded identification bits (block 750). In some embodiments, the control frame can also be in form of the trigger frame, charging frame, management frame, or any other type of downlink frame, for example. In certain embodiments, the control frame can be an 802.11 frame. In more embodiments, the control frame may include a header indicative of control information such as but not limited to sequence numbers, frame type, or error detection codes.

Although a specific embodiment for the process 700 for generating the control frame for carrying out the various steps, processes, methods, and operations described herein is discussed with respect to FIG. 7, any of a variety of systems and/or processes may be utilized in accordance with embodiments of the disclosure. For example, the process 700 may dynamically generate and transmit the control frames to the ambient power devices. The elements depicted in FIG. 7 may also be interchangeable with other elements of FIGS. 1-6 and FIGS. 8-11 as required to realize a particularly desired embodiment.

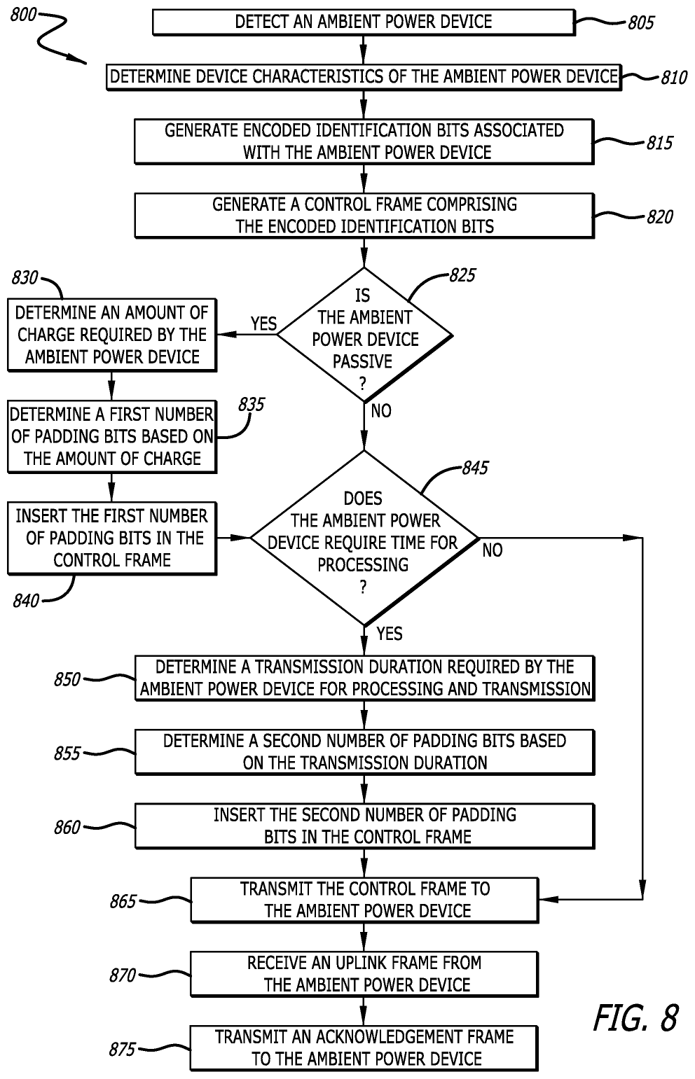

Referring now to FIG. 8, a flowchart depicting a process 800 for inserting the one or more padding bits in the control frame, in accordance with various embodiments of the disclosure is shown. In many embodiments, the process 800 can detect the ambient power device (block 805). In some embodiments, the process 800 can utilize passive scanning, beacon frames, probe requests and responses, analyzing backscatter signals, etc. to detect the ambient power device. In certain embodiments, the ambient power device may share the device characteristics by way of the MUD URL.

In a number of embodiments, the process 800 can determine the device characteristics of the ambient power device (block 810). In some embodiments, the device characteristics may include the device identifier of the ambient power device. In certain embodiments, the examples of the device identifiers can include, but are not limited to EPC, MAC address, serial number, UID or any other such identifiers. In more embodiments, the device characteristics can include the transmission requirements such as but are not limited to the charge level required for transmitting the uplink frames, the time required to charge the energy storage, the buffer size of the buffer, duty cycle of the uplink frames, duty cycle of the charging frames required to charge the energy storage etc. or other such transmission requirements. In some more embodiments, the device characteristics can include the power requirements such as but are not limited to the maximum energy storage capacity of the battery or the capacitor. In numerous embodiments, the process 800 may utilize the device characteristics, including device identifiers, the transmission requirements, and/or power requirements of the ambient power devices to schedule the transmission of the uplink frames transmitted by the ambient power device.

In various embodiments, the process 800 may generate the encoded identification bits associated with the ambient power device (block 815). In some embodiments, the encoded identification bits can be indicative of the device identifier of the ambient power device. In certain embodiments, the process 800 may utilize legacy modulation techniques to generate the encoded identification bits. In more embodiments, the process 800 can encode the device identifiers based on the protocol utilized for communication with the ambient power device.

In additional embodiments, the process 800 can generate the control frame comprising the encoded identification bits (block 820). In some embodiments, the control frame can be the trigger frame or the charging frame, or the control frame can be comprised within the trigger frame or the charging frame. In certain embodiments, the control frame may be indicative of one or more of: the RUs, time slots, zones, or frequencies assigned to the ambient power device. In more embodiments, the control frame can include the resource map and/or the zone map.

In further embodiments, the process 800 may check whether the ambient power device is passive (block 825). In some embodiments, the passive device can reflect the incident RF signals for transmitting the uplink frames. In certain embodiments, the active devices can delay the uplink transmissions by charging the energy storage such as the battery or the capacitor. In more embodiments, the process 800 can determine whether the ambient power device is active device or passive device based on the device characteristics.

If at block 825, the process 800 determines that the ambient power device is the active device, in many more embodiments, the process 800 can determine the amount of charge required by the ambient power device (block 830). In some embodiments, the amount of charge required by the ambient power device can depend on one or more of: the maximum energy storage capacity of the ambient power device, the charge required by the ambient power device to generate and process the uplink data, the priority of the uplink transmission, or the duration or power of the uplink transmission. In certain embodiments, the process 800 may determine the amount of charge required to recharge the ambient power and/or to trigger the uplink transmission by the ambient power device.

In many additional embodiments, the process 800 may determine a first number of padding bits based on the amount of charge required by the ambient power device (block 835). In some embodiments, the first number of padding bits can include a sequence of Is transmitted to the ambient power device. In certain embodiments, the process 800 can choose the number of padding bits such that a length of the control frame is greater than a length of the uplink frame transmitted by the ambient power device. In more embodiments, the first number of padding bits can be transmitted in a time slot intended for the SIFS.

In many further embodiments, the process 800 can insert the first number of padding bits in the control frame (block 840). In some embodiments, the process 800 may extend the control frame by inserting the first number of padding bits. In certain embodiments, the first number of padding bits can be utilized by the ambient power device to backscatter or to recharge the energy storage.

After block 840, and/or if at block 825, the process 800 determines that the ambient power device is not the active device, in many more embodiments, the process 800 can check if the ambient power device requires time for processing (block 845). In some embodiments, the ambient power device may be a sensor such as but not limited to the temperature sensors, humidity sensors, or pressure sensors, etc. for example. In certain embodiments, in such a case, the ambient power device can require a time for sensing temperature, humidity, or pressure values etc. by a transducer, for example. In more embodiments, the ambient power device may require more time to process the measured values and generate the uplink data. In some more embodiments, the ambient power device can also require time to store the uplink data in the buffer and schedule the uplink data for transmission. In numerous embodiments, the ambient power device may also require time to generate the uplink frames by backscattering.

If at block 845, the process 800 determines that the ambient power device requires time for processing, in many more embodiments, the process 800 can determine the transmission duration required by the ambient power device for processing and transmission (block 850). In some embodiments, the transmission duration can be associated with the length or duration of the uplink frames, a status of the buffer, power or amplitude of transmission of the uplink frames, or priority of the uplink data, etc. In certain embodiments, the process 800 may estimate the transmission duration required by each ambient power device by way of one or more ML techniques.

In still many embodiments, the process 800 can determine a second number of padding bits based on the transmission duration (block 855). In some embodiments, the second number of padding bits can extend the control frame such that the ambient power device may measure, process, or transmit the uplink data. In certain embodiments, the second number of padding bits may be determined based on the protocol utilized for communication with the ambient power device.

In still further embodiments, the process 800 may insert the second number of padding bits in the control frame (block 860). In some embodiments, the process 800 can insert the sequence of Is in the control frame. In more embodiments, the process 800 may insert the second number of padding bits in the control frame based on one or more of: a desired frame structure, one or more protocol specifications, or one or more requirements of the wireless communication system.

After block 860, and/or if at block 845, the process 800 determines that the ambient power device does not require time for processing, in many more embodiments, the process 800 can transmit the control frame to the ambient power device (block 865). In some embodiments, the control frame may include one or more fields such as but not limited to the type of frame, header information, or payload data such as but not limited to the resource map, the encoded identification bits, or the zone map, error detection or correction codes, etc. for example. In certain embodiments, the process 800 may transmit the control frame in the TXOP reserved for the ambient power device. In more embodiments, the process 800 can transmit the control frame in the one or more time slots or frequencies associated with the ambient power device.

In many embodiments, the process 800 may receive the uplink frame from the ambient power device (block 870). In some embodiments, the process 800 can employ one or more techniques such as carrier sensing or synchronization to detect the incoming uplink frames. In certain embodiments, the process 800 may demodulate the uplink frames to retrieve the uplink data. In more embodiments, the uplink data may be indicative of the values of the physical parameters measured by the sensors associated with the ambient power device. In some more embodiments, the uplink data can be indicative of the status or mode of operation of the ambient power device. In certain embodiments, the uplink data can also be indicative of renegotiating the frequencies and/or time slots assigned to the ambient power devices.

In a number of embodiments, the process 800 can transmit the acknowledgement frame to the ambient power device (block 875). In some embodiments, the process 800 may transmit the multi-user bulk acknowledgement frame to the multiple ambient power devices. In certain embodiments, the acknowledgement frame can be indicative of the successful reception of the uplink data by the process 800.

Although a specific embodiment for the process 800 for inserting the one or more padding bits in the control frame for carrying out the various steps, processes, methods, and operations described herein is discussed with respect to FIG. 8, any of a variety of systems and/or processes may be utilized in accordance with embodiments of the disclosure. For example, the process 800 may dynamically change the length or duration of the control frame based on changes in transmission duration or transmission requirements of the ambient power device. The elements depicted in FIG. 8 may also be interchangeable with other elements of FIGS. 1-7 and FIGS. 9-11 as required to realize a particularly desired embodiment.

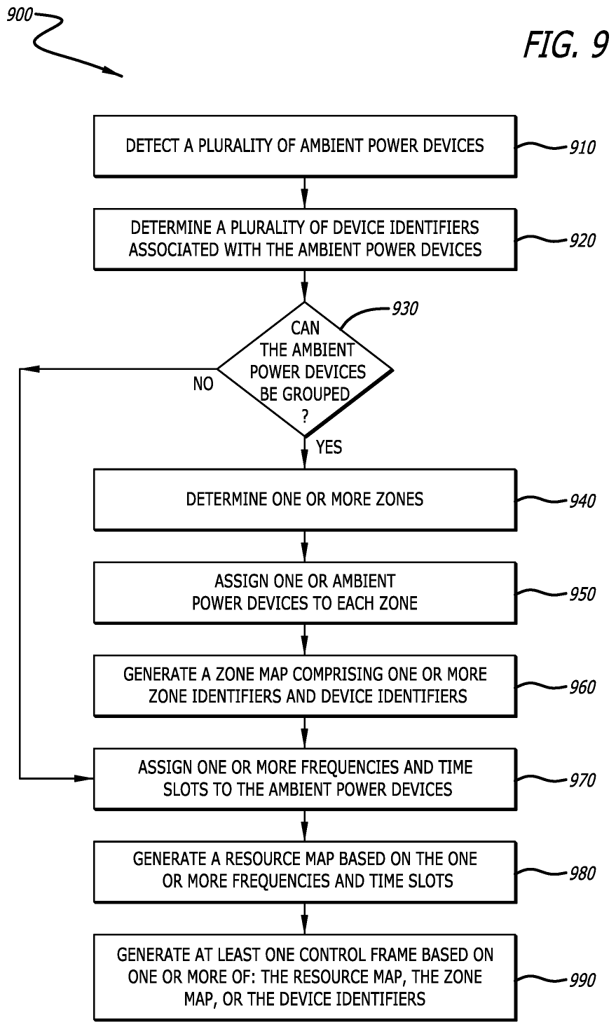

Referring now to FIG. 9, a flowchart depicting a process 900 for organizing the ambient power devices into the zones, in accordance with various embodiments of the disclosure is shown. In many embodiments, the process 900 can detect the ambient power devices (block 910). In some embodiments, the process 900 may detect the ambient power devices by way of one or more of: RF scanning, beacon or broadcast messages, physical proximity sensors, energy harvesting signatures, or network discovery protocols, etc. In certain embodiments, the process 900 can implement one or more ML techniques or a combination of sensing, monitoring, and analysis techniques tailored to detect different types of ambient power devices.

In a number of embodiments, the process 900 can determine the device identifiers associated with the ambient power devices (block 920). In some embodiments, the process 900 may authorize and/or authenticate the ambient power devices based on the device identifiers and device characteristics. In certain embodiments, the process 900 can retrieve the device identifiers from one or more databases comprising device information about the ambient power devices. In more embodiments, the process 900 may discover the device identifiers associated with the ambient power devices by employing a combination of one or more of: network scanning, protocol analysis, physical inspection, and database lookup techniques. In some more embodiments, some ambient power devices can periodically or dynamically advertise the device identifiers and/or device characteristics by way of beacon or advertisement messages.

In various embodiments, the process 900 may check if the ambient power devices can be grouped (block 930). In some embodiments, the ambient power devices can be grouped into the zones based on locations of the ambient power devices. In certain embodiments, the ambient power devices may be grouped into the zones based on proximity of the ambient power devices to the AP or the wireless devices. In more embodiments, the ambient power devices can be grouped into the zones based on similarity in transmission or uplink characteristics such as but not limited to protocols, amplitudes, multiplexing schemes, transmission frequency, etc. for example. In some more embodiments, the process 900 may group the ambient power devices into the zones based on power consumption profiles of the ambient power devices, functions of the ambient power devices, the device characteristics of the ambient power devices, etc. for example.

If at block 930, the process 900 determines that the ambient power devices can be grouped, in additional embodiments, the process 900 can determine the one or more zones (block 940). In some embodiments, the process 900 can assign one or more zone identifiers to each zone. In more embodiments, the process 900 can organize the ambient power devices into multiple zones based on one or more of: geographical partitioning. clustering techniques, signal strength and coverage analysis, ML techniques, or user-defined or network-defined rules or policies etc. for example.

In further embodiments, the process 900 can assign one or ambient power devices to each zone (block 950). In some embodiments, the process 900 may communicate the assignment of the zones to each ambient power device by way of the control frame. In more embodiments, the assignment of the ambient power devices to each zone can be updated by the process 900 dynamically or periodically. In some more embodiments, the process 900 may update the zones and the ambient power devices assigned thereto dynamically in response to changes in network conditions or topology of the ambient power devices.

In many more embodiments, the process 900 may generate the zone map comprising the zone identifiers and device identifiers (block 960). In some embodiments, the zone map can further indicate assignment of the RUs to the ambient power devices in the zones. In certain embodiments, the zone map may also indicate the transmission slots, frequencies, transmission orders, or TXOPs associated with the ambient power devices in the zones.

In many additional embodiments, the process 900 can assign the frequencies and time slots to the ambient power devices (block 970). In some embodiments, the process 900 may implement TDMA and/or OFDMA to schedule transmissions from the ambient power devices. In certain embodiments, the process 900 can implement different multiplexing techniques in different zones or different multiplexing techniques for different types of the ambient power devices simultaneously.

In many further embodiments, the process 900 may generate the resource map based on the frequencies and time slots (block 980). In some embodiments, the process 900 can continuously or periodically monitor performance of resource allocation schemes and utilization of the frequencies and time slots and accordingly update the resource map or generate a new resource map. In certain embodiments, the process 900 can generate a separate resource map for each zone or a single resource map for all the zones.

In still many embodiments, the process 900 can generate the control frame based on one or more of: the resource map, the zone map, or the device identifiers (block 990). In some embodiments, the control frame may be the trigger frame or the charging frame. In certain embodiments, the control frame can be extended by inserting one or more padding bits. In more embodiments, the process 900 can generate a separate control frame for each ambient power device or each zone of ambient power devices. In some more embodiments, the process 900 may transmit a single control frame by way of broadcast or multi-cast to the ambient power devices.

Although a specific embodiment for the process 900 for organizing the ambient power devices into the zones for carrying out the various steps, processes, methods, and operations described herein is discussed with respect to FIG. 9, any of a variety of systems and/or processes may be utilized in accordance with embodiments of the disclosure. For example, the process 900 may dynamically reorganize the zones based on the changes in the network conditions or the changes in the topology of the ambient power devices. The elements depicted in FIG. 9 may also be interchangeable with other elements of FIGS. 1-8 and FIGS. 10-11 as required to realize a particularly desired embodiment.

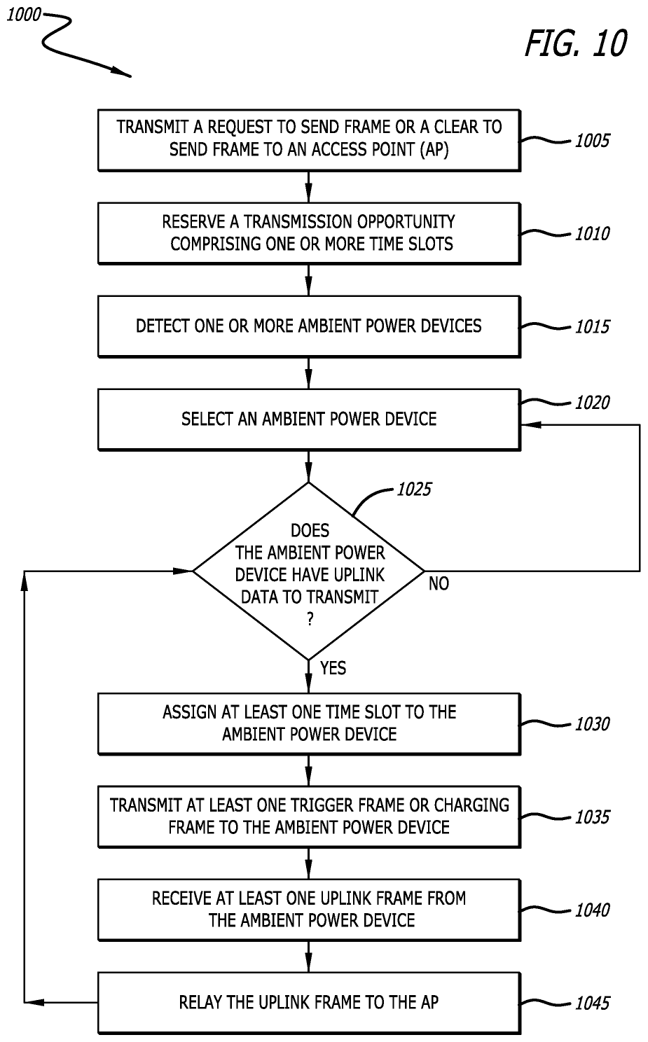

Referring now to FIG. 10, a flowchart depicting a process 1000 for relaying the uplink frames, in accordance with various embodiments of the disclosure is shown. In many embodiments, the process 1000 can transmit the RTS frame or the CTS2Self frame to the AP (block 1005). In some embodiments, the process 1000 can be implemented by the wireless device or the relay. In certain embodiments, the process 1000 may perform the RTS or CTS procedure to reduce collisions of frames exchanged with the AP. In more embodiments, a duration of the RTS and CTS frames, as well as the SIFS therebetween, may be determined based on one or more factors such as but not limited to data transmission rate, network topology, and propagation delays.

In a number of embodiments, the process 1000 may reserve the TXOP comprising the time slots (block 1010). In some embodiments, the process 1000 may reserve the TXOP with the AP by way of the RTS or CTS procedure. In certain embodiments, the TXOP may include one or more frequencies and one or more time slots associated with the frequencies. In more embodiments, the process 1000 may have exclusive access to the reserved time slots during the reserved TXOP.

In various embodiments, the process 1000 can detect the ambient power devices (block 1015). In some embodiments, the process 1000 may utilize passive scanning, beacon frames, probe requests and responses, analysis of backscatter signals, etc. to detect the ambient power devices. In certain embodiments, the process 1000 may authenticate or authorize the detected ambient power devices.

In additional embodiments, the process 1000 may select an ambient power device (block 1020). In some embodiments, the process 1000 can transfer the reserved TXOP to the ambient power devices. In certain embodiments, the process 1000 may supervise the transmissions by the ambient power devices. In more embodiments, the process 1000 can select one ambient power device at a time based on a predetermined order, or based on a transmission order received from the AP, or based on random selection. In some more embodiments, the process 1000 can select more than one ambient power devices simultaneously to transmit the uplink frames by utilizing one or more multiplexing techniques.

In further embodiments, the process 1000 can check whether the ambient power device has uplink data to transmit (block 1025). In some embodiments, the ambient power devices can be sensors or transducers that measure physical properties such as but not limited to temperature, humidity, or pressure etc. for example. In certain embodiments, the uplink data transmitted by the ambient power devices can be indicative of the measured values. In more embodiments, ambient power devices may only transmit the uplink data at predetermined time intervals or upon changes in the measured values. In such case, in some more embodiments, there can be instances when the ambient power devices do not have the uplink data for transmission. In numerous embodiments, the ambient power devices may not have the uplink data for transmission when the ambient power devices are in sleep mode or power saving mode.

If at block 1025 the process 1000 determines that the ambient power device does not have any uplink data to transmit, in many more embodiments, the process 1000 can select another ambient power device (block 1020). In some embodiments, the process 1000 may iterate the blocks 1020 and 1025 to ensure that all the ambient power devices have been selected and that all the ambient power devices having the uplink data for transmission have received the TXOP to transmit the uplink frames. In certain embodiments, the process 1000 can continuously check for the uplink transmissions in the TXOP reserved for the ambient power devices.

If at block 1025 the process 1000 determines that the ambient power device has the uplink data to transmit, in many additional embodiments, the process 1000 can assign at least one time slot to the ambient power device (block 1030). In some embodiments, the process 1000 can also communicate the frequencies corresponding to the time slot to the ambient power device. In certain embodiments, the process 1000 may assign multiple time slots to the ambient power device based on the volume of the uplink data and/or the length or duration of the uplink frame. In more embodiments, the process 1000 may also assign multiple time slots to the ambient power device based on the uplink data in the buffer of the ambient power device and/or the priority of the uplink data.

In many further embodiments, the process 1000 can transmit at least one trigger frame to the ambient power device (block 1035). In some embodiments, the trigger frame can be indicative of the RUs allocation, time slots and/or frequency allocation, or transmission order associated with the ambient power device. In certain embodiments, the trigger frame can be extended by the process 1000 by inserting the padding bits to charge the ambient power device. In more embodiments, the process 1000 may utilize spatial diversity to charge or trigger the ambient power devices at different locations by way of beamforming. In numerous embodiments, the process 1000 may perform the beamforming to charge or trigger the ambient power devices in different locations or different directions. In some more embodiments, the process 1000 can generate and transmit a beamformed signal to the ambient power devices. In many more embodiments, the beamformed signal can include the trigger frame, the charging frame, or the control frame, for example.

In still many embodiments, the process 1000 may receive the uplink frame from the ambient power device (block 1040). In some embodiments, the uplink frame can be transmitted by the ambient power device by backscattering such as but not limited to monostatic backscatter, bistatic back scatter, or ambient backscatter. In certain embodiments, the uplink frame may be modulated by one or more modulation or spreading techniques.

In still further embodiments, the process 1000 can relay the uplink frame to the AP (block 1045). In some embodiments, the process 1000 may function as the receiver and energizer for the ambient power devices and may also supervise the uplink transmissions by the ambient power devices. In certain embodiments, the process 1000 can share 802.11 frames to communicate with the AP. In more embodiments, the process 1000 may relay the uplink frames in real-time or near-real time. In some more embodiments, the process 1000 can utilize a buffer or a queue to store or enqueue the uplink frames prior to relaying.

Although a specific embodiment for the process 1000 for relaying the uplink frames for carrying out the various steps, processes, methods, and operations described herein is discussed with respect to FIG. 10, any of a variety of systems and/or processes may be utilized in accordance with embodiments of the disclosure. For example, the process 1000 may be implemented by more than one relays or wireless devices between the AP and the ambient power devices. The elements depicted in FIG. 10 may also be interchangeable with other elements of FIGS. 1-9 and FIG. 11 as required to realize a particularly desired embodiment.

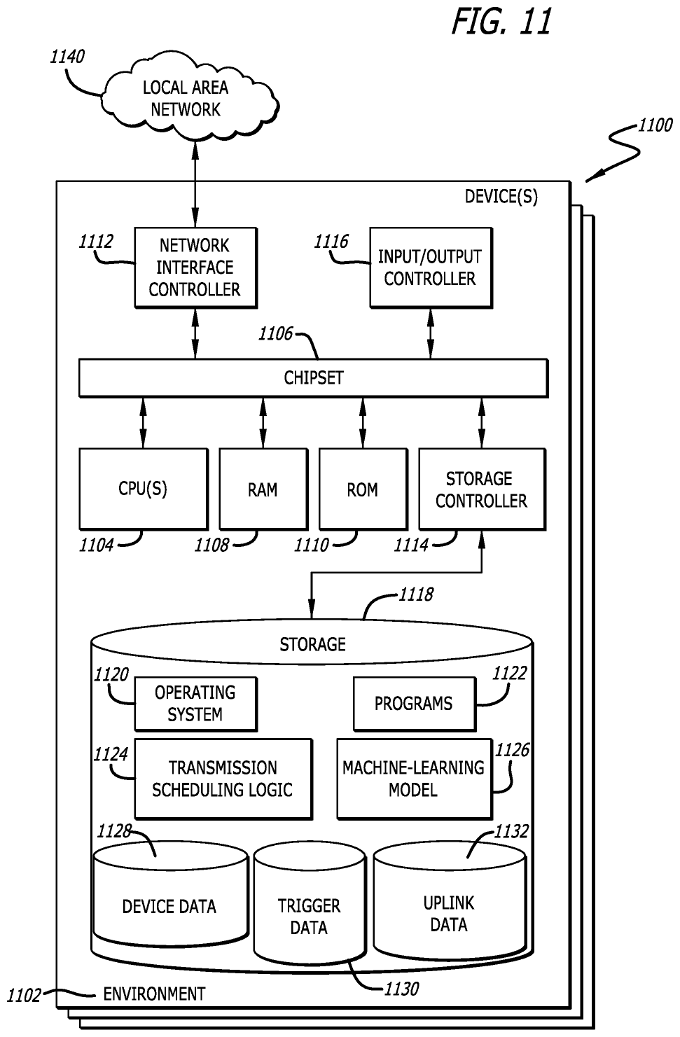

Referring to FIG. 11, a conceptual block diagram of a device 1100 suitable for configuration with a transmission scheduling logic, in accordance with various embodiments of the disclosure is shown. The embodiment of the conceptual block diagram depicted in FIG. 11 can illustrate a conventional server, computer, workstation, desktop computer, laptop, tablet, network appliance, e-reader, smartphone, or other computing device, and can be utilized to execute any of the application and/or logic components presented herein. The embodiment of the conceptual block diagram depicted in FIG. 11 can also illustrate an access point, a switch, or a router in accordance with various embodiments of the disclosure. The device 1100 may, in many non-limiting examples, correspond to physical devices or to virtual resources described herein.

In many embodiments, the device 1100 may include an environment 1102 such as a baseboard or “motherboard,” in physical embodiments that can be configured as a printed circuit board with a multitude of components or devices connected by way of a system bus or other electrical communication paths. Conceptually, in virtualized embodiments, the environment 1102 may be a virtual environment that encompasses and executes the remaining components and resources of the device 1100. In more embodiments, one or more processors 1104, such as, but not limited to, central processing units (“CPUs”) can be configured to operate in conjunction with a chipset 1106. The processor(s) 1104 can be standard programmable CPUs that perform arithmetic and logical operations necessary for the operation of the device 1100.

In a number of embodiments, the processor(s) 1104 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In various embodiments, the chipset 1106 may provide an interface between the processor(s) 1104 and the remainder of the components and devices within the environment 1102. The chipset 1106 can provide an interface to a random-access memory (“RAM”) 1108, which can be used as the main memory in the device 1100 in some embodiments. The chipset 1106 can further be configured to provide an interface to a computer-readable storage medium such as a read-only memory (“ROM”) 1110 or non-volatile RAM (“NVRAM”) for storing basic routines that can help with various tasks such as, but not limited to, starting up the device 1100 and/or transferring information between the various components and devices. The ROM 1110 or NVRAM can also store other application components necessary for the operation of the device 1100 in accordance with various embodiments described herein.

Additional embodiments of the device 1100 can be configured to operate in a networked environment using logical connections to remote computing devices and computer systems through a network, such as the network 1140. The chipset 1106 can include functionality for providing network connectivity through a network interface card (“NIC”) 1112, which may comprise a gigabit Ethernet adapter or similar component. The NIC 1112 can be capable of connecting the device 1100 to other devices over the network 1140. It is contemplated that multiple NICs 1112 may be present in the device 1100, connecting the device to other types of networks and remote systems.

In further embodiments, the device 1100 can be connected to a storage 1118 that provides non-volatile storage for data accessible by the device 1100. The storage 1118 can, for instance, store an operating system 1120, applications 1122, device data 1128, trigger data 1130, and uplink data 1132 which are described in greater detail below. The storage 1118 can be connected to the environment 1102 through a storage controller 1114 connected to the chipset 1106. In certain embodiments, the storage 1118 can consist of one or more physical storage units. The storage controller 1114 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units. The device data 1128 may store the device characteristics of the ambient power devices. In some embodiments, the device data 1128 can store the transmission requirements or power requirements of the ambient power devices. The device data 1128 may also store the device identifiers and/or MUD data, MUD URL etc. of the ambient power devices. The trigger data 1130 can store the RUs allocated to the ambient power devices, the transmission order of the ambient power devices, the frequencies or time slots assigned to the ambient power devices, or the zones assigned to the ambient power devices. The trigger data 1130 may also store the control frames, trigger frames, charging frames, management frames, or downlink frames etc. The trigger data 1130 can also store the resource map and the zone map. The uplink data 1132 can store the uplink data and/or the uplink frames received from the ambient power devices.

The device 1100 can store data within the storage 1118 by transforming the physical state of the physical storage units to reflect the information being stored. The specific transformation of physical state can depend on various factors. Examples of such factors can include, but are not limited to, the technology used to implement the physical storage units, whether the storage 1118 is characterized as primary or secondary storage, and the like.

In many more embodiments, the device 1100 can store information within the storage 1118 by issuing instructions through the storage controller 1114 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 1100 can further read or access information from the storage 1118 by detecting the physical states or characteristics of one or more particular locations within the physical storage units.

In addition to the storage 1118 described above, the device 1100 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 1100. In some examples, the operations performed by a cloud computing network, and or any components included therein, may be supported by one or more devices similar to device 1100. Stated otherwise, some or all of the operations performed by the cloud computing network, and or any components included therein, may be performed by one or more devices 1100 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage 1118 can store an operating system 1120 utilized to control the operation of the device 1100. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage 1118 can store other system or application programs and data utilized by the device 1100.

In many additional embodiments, the storage 1118 or other computer-readable storage media is encoded with computer-executable instructions which, when loaded into the device 1100, may transform it from a general-purpose computing system into a special-purpose computer capable of implementing the embodiments described herein. These computer-executable instructions may be stored as application 1122 and transform the device 1100 by specifying how the processor(s) 1104 can transition between states, as described above. In some embodiments, the device 1100 has access to computer-readable storage media storing computer-executable instructions which, when executed by the device 1100, perform the various processes described above with regard to FIGS. 1-10. In certain embodiments, the device 1100 can also include computer-readable storage media having instructions stored thereupon for performing any of the other computer-implemented operations described herein.

In many further embodiments, the device 1100 may include a transmission scheduling logic 1124. The transmission scheduling logic 1124 can be configured to perform one or more of the various steps, processes, operations, and/or other methods that are described above. Often, the transmission scheduling logic 1124 can be a set of instructions stored within a non-volatile memory that, when executed by the processor(s)/controller(s) 1104 can carry out these steps, etc. In some embodiments, the transmission scheduling logic 1124 may be a client application that resides on a network-connected device, such as, but not limited to, a server, switch, personal or mobile computing device in a single or distributed arrangement. The transmission scheduling logic 1124 can charge the ambient power devices, schedule uplink transmissions from the ambient power devices, or organize the ambient power devices into the zones etc.

In still further embodiments, the device 1100 can also include one or more input/output controllers 1116 for receiving and processing input from a number of input devices, such as a keyboard, a mouse, a touchpad, a touch screen, an electronic stylus, or other type of input device. Similarly, an input/output controller 1116 can be configured to provide output to a display, such as a computer monitor, a flat panel display, a digital projector, a printer, or other type of output device. Those skilled in the art will recognize that the device 1100 might not include all of the components shown in FIG. 11 and can include other components that are not explicitly shown in FIG. 11 or might utilize an architecture completely different than that shown in FIG. 11.

As described above, the device 1100 may support a virtualization layer, such as one or more virtual resources executing on the device 1100. In some examples, the virtualization layer may be supported by a hypervisor that provides one or more virtual machines running on the device 1100 to perform functions described herein. The virtualization layer may generally support a virtual resource that performs at least a portion of the techniques described herein.

Finally, in numerous additional embodiments, data may be processed into a format usable by a machine-learning model 1126 (e.g., feature vectors), and or other pre-processing techniques. The machine-learning (“ML”) model 1126 may be any type of ML model, such as supervised models, reinforcement models, and/or unsupervised models. The ML model 1126 may include one or more of linear regression models, logistic regression models, decision trees, Naïve Bayes models, neural networks, k-means cluster models, random forest models, and/or other types of ML models 1126.

The ML model(s) 1126 can be configured to generate inferences to make predictions or draw conclusions from data. An inference can be considered the output of a process of applying a model to new data. This can occur by learning from at least the device data 1128, the trigger data 1130, and the uplink data 1132 and use that learning to predict future outcomes. These predictions are based on patterns and relationships discovered within the data. To generate an inference, the trained model can take input data and produce a prediction or a decision. The input data can be in various forms, such as images, audio, text, or numerical data, depending on the type of problem the model was trained to solve. The output of the model can also vary depending on the problem, and can be a single number, a probability distribution, a set of labels, a decision about an action to take, etc. Ground truth for the ML model(s) 1126 may be generated by human/administrator verifications or may compare predicted outcomes with actual outcomes.

Although a specific embodiment for the device 1100 suitable for configuration with the transmission scheduling logic for carrying out the various steps, processes, methods, and operations described herein is discussed with respect to FIG. 11, any of a variety of systems and/or processes may be utilized in accordance with embodiments of the disclosure. For example, the device 1100 may be in a virtual environment such as a cloud-based network administration suite, or it may be distributed across a variety of network devices or switches. The elements depicted in FIG. 11 may also be interchangeable with other elements of FIGS. 1-10 as required to realize a particularly desired embodiment.

Although the present disclosure has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A device, comprising:
a processor;
a memory communicatively coupled to the processor; and
a transmission scheduling logic, configured to:
detect a plurality of ambient power devices;
determine one or more device identifiers associated with one or more ambient power devices of the plurality of ambient power devices;
determine one or more transmission durations associated with the one or more ambient power devices; and
generate at least one control frame based on the one or more device identifiers and the one or more transmission durations.

2. The device of claim 1, wherein the transmission scheduling logic is further configured to:
assign one or more frequencies to the one or more ambient power devices; and
assign one or more time slots to the one or more ambient power devices.

3. The device of claim 2, wherein the transmission scheduling logic is further configured to generate a resource map indicative of the one or more device identifiers and at least one of: the one or more frequencies or the one or more time slots.

4. The device of claim 3, wherein the transmission scheduling logic is further configured to generate one or more encoded identification bits based on the one or more device identifiers.

5. The device of claim 4, wherein the transmission scheduling logic is further configured to generate one or more padding bits based on the one or more transmission durations.

6. The device of claim 5, wherein the transmission scheduling logic is further configured to:
organize the plurality of ambient power devices into one or more zones;
assign one or more zone identifiers to the one or more zones; and
generate a zone map indicative of assignment of the one or more device identifiers to the one or more zone identifiers.

7. The device of claim 6, wherein the at least one control frame comprises at least one of: the one or more encoded identification bits, the one or more padding bits, the resource map, or the zone map.

8. The device of claim 7, wherein the at least one control frame is a trigger frame or a charging frame.

9. The device of claim 8, wherein the one or more transmission durations are indicative of a time required for charging the one or more ambient power devices.

10. The device of claim 9, wherein the transmission scheduling logic is further configured to:
reserve a transmission opportunity comprising the one or more time slots; and
assign the transmission opportunity to the one or more ambient power devices.

11. The device of claim 10, wherein reserving the transmission opportunity comprises transmitting a request to send frame or a clear to send frame to a wireless device.

12. The device of claim 11, wherein the transmission scheduling logic is further configured to transmit a beamformed signal to the one or more ambient power devices.

13. The device of claim 12, wherein the beamformed signal comprises the trigger frame or the charging frame.

14. A device, comprising:
a processor;
a memory communicatively coupled to the processor; and
a transmission scheduling logic, configured to:
detect a plurality of ambient power devices;
determine one or more device identifiers associated with one or more ambient power devices of the plurality of ambient power devices;
generate one or more encoded identification bits indicative of the one or more device identifiers; and
generate at least one trigger frame comprising the one or more encoded identification bits.

15. The device of claim 14, wherein the transmission scheduling logic is further configured to:
determine one or more transmission durations associated with the one or more ambient power devices; and
insert one or more padding bits in the at least one trigger frame based on the one or more transmission durations.

16. The device of claim 15, wherein the transmission scheduling logic is further configured to transmit the at least one trigger frame to the one or more ambient power devices.

17. The device of claim 16, wherein the transmission scheduling logic is further configured to receive one or more uplink frames from the one or more ambient power devices in response to the at least one trigger frame.

18. A method, comprising:
detecting a plurality of ambient power devices;
determining one or more device identifiers associated with one or more ambient power devices of the plurality of ambient power devices;
determining one or more transmission durations associated with the one or more ambient power devices; and
generating at least one control frame based on the one or more device identifiers and the one or more transmission durations.

19. The method of claim 18, further comprising:
generating one or more encoded identification bits based on the one or more device identifiers;
generating one or more padding bits based on the one or more transmission durations; and
generating a resource map indicative of assignment of at least one of: one or more frequencies or one or more time slots to the one or more ambient power devices.

20. The method of claim 19, wherein the at least one control frame comprises at least one of: the one or more encoded identification bits, the one or more padding bits, or the resource map.
